(19) United States
(12) Patent Application Publication
(10) Pub. No.: US 2011/0062792 A1
(43) Pub. Date: Mar. 17, 2011

(54) POWER-SUPPLY CONTROL DEVICE AND POWER-SUPPLY CONTROL METHOD

(75) Inventor: Jun Okazaki, Kanagawa (JP)

(73) Assignee: KABUSHIKI KAISHA TOSHIBA, Tokyo (JP)

(21) Appl. No.: 12/836,870

(22) Filed: Jul. 15, 2010

(30) Foreign Application Priority Data
Sep. 14, 2009 (JP) 2009-212287

(51) Int. Cl. H01H 35/00

(52) U.S. Cl. 307/116

(57) ABSTRACT

According to one embodiment, a power-supply control device includes a connecting unit to which another electric apparatus different from the electric apparatus can be connected; an apparatus discriminating unit that discriminates whether the electric apparatus is a controlling-side electric apparatus that controls supply of electric power to the other electric apparatus; a switching unit that switches supply and interruption of electric power supplied from the commercial power supply to the other electric apparatus connected to the connecting unit; and a control unit that controls the supply and the interruption of electric power by the switching unit when the apparatus discriminating unit discriminates that the electric apparatus is the controlling-side electric apparatus.

### CROSS-REFERENCE TO RELATED APPLICATIONS

This application is based upon and claims the benefit of priority from the prior Japanese Patent Application No. 2009-212287, filed on Sep. 14, 2009; the entire contents of which are incorporated herein by reference.

### FIELD

Embodiments described herein relate generally to a power-supply control device and a power-supply control method.

### BACKGROUND

There is a demand for a reduction in standby power for the purpose of a reduction in power consumption in an electric apparatus connected to a commercial power supply and used. During the stop of the electric apparatus, the standby power can be reduced to zero if a power supply plug is pulled out from a power supply socket. However, it is troublesome to pull out the power supply plug every time the electric apparatus is stopped. An excessive burden is imposed on a user. Therefore, a technology for a control device for automatically interrupting supply of electric power during the stop of a controlled-side electric apparatus is disclosed.

However, in the related art, because the control device is provided separately from the electric apparatus, a user may be unwilling to take the trouble to prepare the device separately from the electric apparatus. Some user feels it annoying to consider a configuration for connecting the separate device and the electric apparatus.

### BRIEF DESCRIPTION OF THE DRAWINGS

FIG. 1 is a block diagram of the schematic configuration of electric apparatuses including power-supply control devices according to a first embodiment;

FIG. 2 is a flowchart for explaining a procedure for the power-supply control device to decide whether a DVD recorder is a controlling-side electric apparatus;

FIG. 3 is a flowchart for explaining a procedure for power supply control by the power-supply control device of the DVD recorder as the controlling-side electric apparatus;

FIG. 4 is a block diagram of the schematic configuration of electric apparatuses including power-supply control devices according to a second embodiment; and

FIG. 5 is a flowchart for explaining a procedure for an apparatus discriminating unit to discriminate, based on power consumptions, whether a connection configuration is appropriate for a reduction in standby powers.

### DETAILED DESCRIPTION

In general, according to one embodiment, a power-supply control device is provided in an electric apparatus connected to a commercial power supply and includes: a connecting unit to which another electric apparatus different from the electric apparatus can be connected; an apparatus discriminating unit that discriminates whether the electric apparatus is a controlling-side electric apparatus that controls supply of electric power to the other electric apparatus; a switching unit that switches supply and interruption of electric power supplied from the commercial power supply to the other electric apparatus connected to the connecting unit; and a control unit that controls the supply and the interruption of electric power by the switching unit when the apparatus discriminating unit discriminates that the electric apparatus is the controlling-side electric apparatus.

Exemplary embodiments of a power-supply control device and a power-supply control method will be explained below in detail with reference to the accompanying drawings. The present invention is not limited to the following embodiments.

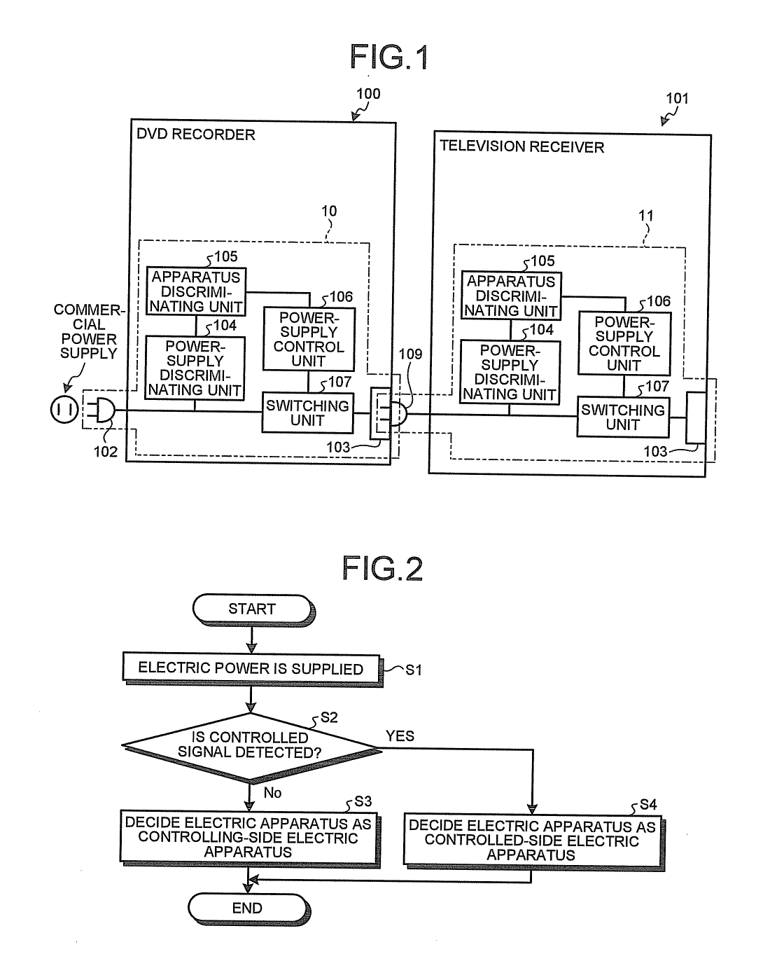

FIG. 1 is a block diagram of the schematic configuration of electric apparatuses including power-supply control devices according to a first embodiment. In the first embodiment, a digital versatile disc (DVD) recorder 100 and a television receiver 101 are explained as examples of the electric apparatuses.

In the explanation of the embodiments, a controlling-side electric apparatus means an electric apparatus to which electric power is always supplied, for example, when the electric apparatus is connected to a commercial power supply. A controlled-side electric apparatus means an electric apparatus that is connected to a connecting unit included in the controlling-side electric apparatus and receives supply of electric power via the controlling-side electric apparatus. Supply and interruption of electric power to the controlled-side electric apparatus are controlled by the controlling-side electric apparatus.

The DVD recorder 100 records, in a hard disk drive incorporated in the DVD recorder 100 or a DVD as a storage medium, program data and the like obtained from a broadcast signal received by a tuner. The DVD recorder 100 transmits the program data and the like read from the DVD or the hard disk drive to a display device of the television receiver 101 or the like. Components such as the hard disk drive and the tuner included in the DVD recorder 100 to realize these functions are not shown in the figure. A state in which the DVD recorder 100 records the program data and transmits the program data to the display device is referred to as operation state of the DVD recorder 100.

The DVD recorder 100 enters a standby state when electric power is supplied thereto. The standby state means a state in which the DVD recorder 100 can shift to the operation state when the DVD recorder 100 receives an operation signal from a remote controller or when an operation switch provided in the DVD recorder 100 is operated. When electric power is not supplied, the DVD recorder 100 does not shift to the operation state even if the operation signal is received or the operation switch is operated.

The DVD recorder 100 incorporates a power-supply control device 10. The power-supply control device 10 includes a power supply plug 102, a connecting unit 103, a power-supply discriminating unit 104, an apparatus discriminating unit 105, a power-supply control unit (a control unit) 106, and a switching unit 107.

The power supply plug 102 of the DVD recorder 100 is inserted into a socket provided on a wall surface in a room or connected to a service socket included in the other electric apparatus. The DVD recorder 100 is connected the power supply via the power supply plug 102 and receives supply of electric power. The commercial power supply means, in general, a power supply provided to factories and homes by an electric power company.

The connecting unit 103 is formed in a shape same as the socket provided on the wall surface. A power supply plug of the other electric apparatus different from the electric apparatus incorporating the power-supply control device 10, for example, a power supply plug 109 of the television receiver 101 can be inserted into the connecting unit 103. The connecting unit 103 is called, for example, service socket. The other electric apparatus is connected to the commercial power supply via the DVD recorder 100 when the power supply plug is inserted into the connecting unit 103.

When the power supply plug of the other electric apparatus is inserted, the connecting unit 103 transmits a predetermined signal (hereinafter, “controlled signal”) to the other electric apparatus via the inserted power supply plug. The controlled signal is a signal transmitted to cause the other electric apparatus to recognize that the other electric apparatus is a controlled-side electric apparatus. The connecting unit 103 can include a switch to detect that the power supply plug of the other electric apparatus is inserted or can include a detecting unit that detects a change in capacitance when the power supply plug is inserted.

The power-supply discriminating unit 104 discriminates whether the power supply plug 102 of the DVD recorder 100 is connected to the commercial power supply. Specifically, when electric power is supplied via the power supply plug 102 connected to the socket of the commercial power supply or the service socket of the other electric apparatus, the power-supply discriminating unit 104 discriminates whether the power supply plug 102 is connected to the commercial power supply. When electric power is supplied, the power-supply discriminating unit 104 detects presence or absence of the controlled signal received via the power supply plug 102. When the controlled signal cannot be detected when the power supply plug 102 is inserted into the socket, the power-supply discriminating unit 104 discriminates that the power supply plug 102 is connected to the commercial power supply. On the other hand, when the controlled signal is detected when the power supply plug 102 is inserted into the socket, the power-supply discriminating unit 104 discriminates that the power supply plug 102 is not connected to the commercial power supply. The power-supply discriminating unit 104 transmits a detection result to the apparatus discriminating unit 105.

The apparatus discriminating unit 105 discriminates whether the DVD recorder 100 is the controlling-side electric apparatus or the controlled-side electric apparatus. When the detection result transmitted from the power-supply discriminating unit 104 indicates that the power supply plug 102 is connected to the commercial power supply, the apparatus discriminating unit 105 decides the DVD recorder 100 as the controlling-side electric apparatus. When the detection result transmitted from the power-supply discriminating unit 104 indicates that the power supply plug 102 is not connected to the commercial power supply, the apparatus discriminating unit 105 decides the DVD recorder 100 as the controlled-side electric apparatus. The apparatus discriminating unit 105 transmits a decision result to the power-supply control unit 106. The power-supply discriminating unit 104 and the apparatus discriminating unit 105 can be integrated.

If the decision result transmitted from the apparatus discriminating unit 104 indicates that the DVD recorder 100 is decided as the controlling-side electric apparatus, the power-supply control unit 106 applies power supply control to the controlled-side electric apparatus connected to the connecting unit 103. The power supply control means control for performing, based on predetermined conditions, supply and interruption of electric power to the controlled-side electric apparatus. The power-supply control unit 106 performs the power supply control by causing the switching unit 107 to switch the supply and the interruption of electric power to the controlled-side electric apparatus. When the decision result transmitted from the apparatus discriminating unit 104 indicates that the DVD recorder 100 is decided as the controlled-side electric apparatus, the power-supply control unit 106 does not perform the power supply control. The predetermined conditions for performing the control of the supply and the interruption of electric power to the controlled-side electric apparatus are explained in detail later.

The switching unit 107 is provided between the power supply plug 102 and the connecting unit 103. The switching unit 107 switches supply and interruption of electric power, which is supplied via the power supply plug 102, to the connecting unit 103. When electric power is supplied to the connecting unit 103, electric power is supplied to the controlled-side electric apparatus connected to the connecting unit 103. When the supply of electric power to the connecting unit 103 is interrupted, the supply of electric power to the controlled-side electric apparatus connected to the connecting unit 103 is interrupted. The switching unit 107 switches, based on an instruction from the power-supply control unit 106 that performs the power supply control, the supply and the interruption of electric power to the connecting unit 103.

The television receiver 101 displays a video and the like on a display unit and emits sound from a speaker based on a broadcast signal received by the tuner. The television receiver 101 displays a video and the like on the display unit and emits sound from the speaker based on program data or the like transmitted from the DVD recorder 100. Components such as the display device and the speaker included in the television receiver 101 to realize these functions are not shown in the figure. A state in which the television receiver 101 displays a video on the display unit and emits sound from the speaker is referred to as operation state of the television receiver 101.

The television receiver 101 enters a standby state when electric power is supplied thereto. The standby state means a state in which the television receiver 101 can shift to the operation state when an operation signal from a remote controller is received or an operation switch provided in the television receiver 101 is operated. When electric power is not supplied, the television receiver 101 does not shift to the operation state even if the operation signal is received or the operation switch is operated.

The television receiver 101 has the power supply plug 109. The power supply plug 109 is inserted into the socket provided on the wall surface of the room and connected to the commercial power supply or connected to a connecting unit included in the other electric apparatus. Like the DVD recorder 100, the television receiver 101 includes a power-supply control device 11. Components and functions of the power-supply control device 11 included in the television receiver 101 are substantially the same as those of the power-supply control device 10 included in the DVD recorder 100. Therefore, the components and the functions are denoted by the same reference numerals and detailed explanation of the components and the functions is omitted.

FIG. 2 is a flowchart for explaining a procedure for the power-supply control device 10 to decide whether the DVD recorder 100 is the controlling-side electric apparatus.

When electric power is supplied via the power supply plug 102 (step S1), when the power-supply discriminating unit 104 does not detect a controlled signal (“No” at step S2), the apparatus discriminating unit 105 decides the DVD recorder 100 as the controlling-side electric apparatus (step S3) and transmits a decision result to the power-supply control unit 106. When the power-supply discriminating unit 104 detects the controlled signal (“Yes” at step S2), the apparatus discriminating unit 105 decides the DVD recorder 100 as the controlled-side electric apparatus (step S4) and transmits a decision result to the power-supply control unit 106.

The power-supply control device 11 of the television receiver 101 decides, according to the same procedure, whether the television receiver 101 is the controlling-side electric apparatus. Specifically, whichever of the DVD recorder 100 and the television receiver 101 is directly connected to the commercial power supply, decision of the controlling-side electric apparatus is appropriately performed and appropriate power supply control is performed.

As shown in FIG. 1, the DVD recorder 100 is connected to the commercial power supply and the television receiver 101 is connected to the connecting unit 103 of the DVD recorder 100. In other words, the DVD recorder 100 is set as the controlling-side electric apparatus and the television receiver 101 is set as the controlled-side electric apparatus. Power supply control in this case is explained below.

In an initial state, electric power is not supplied to the television receiver 101. The DVD recorder 100 as the controlling-side electric apparatus receives an operation signal transmitted from the remote controller to cause the television receiver 101 as the controlled-side electric apparatus to operate. When the power-supply control unit 106 of the power-supply control device 10 incorporated in the DVD recorder 100 receives the operation signal to the television receiver 101, the power-supply control unit 106 controls the switching unit 107 to supply electric power to the television receiver 101.

At a point when the operation signal is transmitted from the remote controller, because electric power is not supplied to the television receiver 101, the television receiver 101 cannot shift to the operation state. Therefore, the power-supply control unit 106 causes, after supplying electric power to the television receiver 101, a not-shown transmitting unit to transmit the operation signal to the television receiver 101 again and causes the television receiver 101 to shift to the operation state. When the television receiver 101 immediately shifts to the operation state not through the standby state when electric power is supplied thereto, it is unnecessary to transmit the operation signal again.

The DVD recorder 100 receives a standby signal transmitted from the remote controller to shift the operating television receiver 101 to the standby state. When the power-supply control unit 106 receives the standby signal, the power-supply control unit 106 controls the switching unit 107 to interrupt the supply of electric power to the television receiver 101. To interrupt the supply of electric power after processing for shift to the standby state in the television receiver 101 is surely completed, delay means can be provided such that the supply of electric power can be interrupted when a fixed time elapses after the standby signal is received.

Therefore, in the first embodiment, an instruction for shift to the operation state and an instruction for shift to the standby state given to the television receiver 101 are the predetermined conditions for the power-supply control unit 106 to perform the control for supply and interruption of electric power.

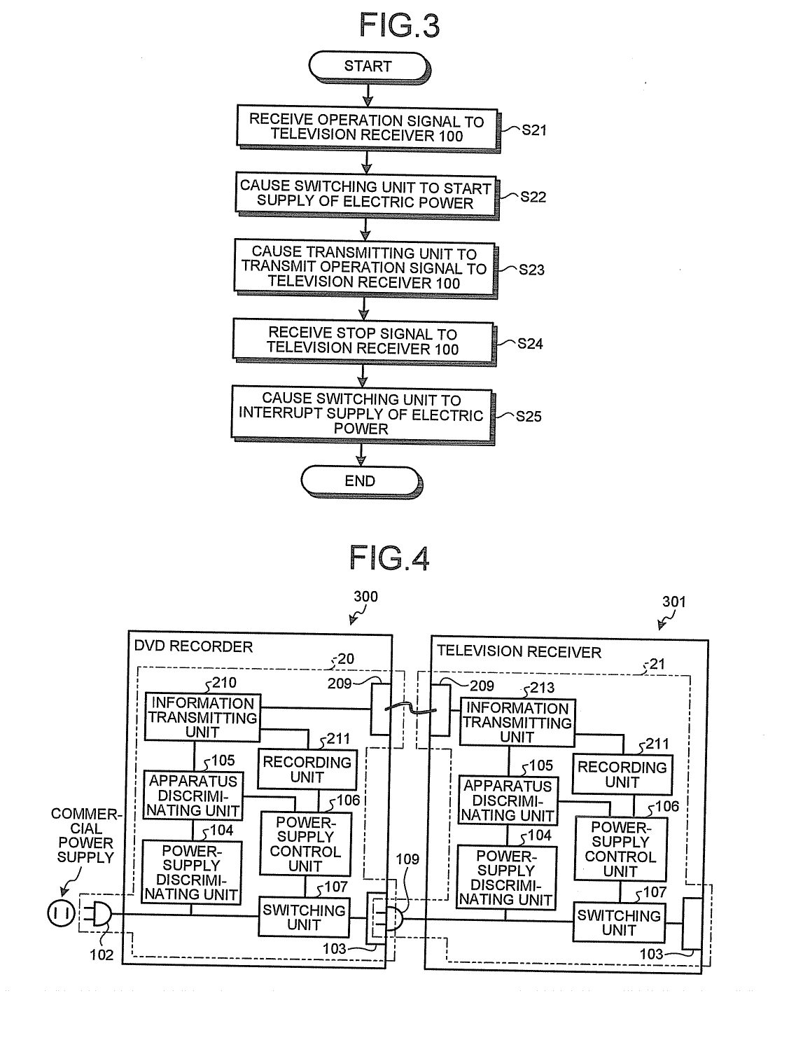

FIG. 3 is a flowchart for explaining a procedure of power supply control by the power-supply control device 10 of the DVD recorder 100 as the controlling-side electric apparatus.

When a receiving unit of the DVD player 100 receives an operation signal transmitted from the remote controller to the television receiver 101 (step S21), the power-supply control unit 106 causes the switching unit 107 to start supply of electric power to the television receiver 101 (step S22). Thereafter, the power-supply control unit 106 causes the transmitting unit to transmit the operation signal to the television receiver 101 (step S23). When the television receiver 101 is in the operation state, the receiving unit receives a stop signal from the remote controller (step S24). The power-supply control unit 106 causes the switching unit 107 to interrupt the supply of electric power to the television receiver 101 (step S25).

As explained above, the power-supply control devices 10 and 11 included in the DVD recorder 100 and the television receiver 101 discriminate and decide, according to connection destinations of the power supply plugs, whether the DVD recorder 100 and the television receiver 101 are the controlling-side electric apparatus or the controlled-side electric apparatus. Therefore, the user can use the electric apparatuses without worrying about connection order of the electric apparatuses.

Because supply and interruption of electric power are controlled according to a state of the controlled-side electric apparatus, it is possible to reduce standby power without pulling out and inserting the power supply plug and reduce a burden on the user. Because the power-supply control device is incorporated in the electric apparatus, a control device does not have to be provided separately from the electric apparatus. The user can easily install the electric apparatus.

A method of discriminating, with the power-supply discriminating unit 104, whether the electric apparatus is connected to the commercial power supply is not limited to the method explained above. For example, the power-supply discriminating unit 104 can discriminate, when a predetermined signal transmitted from the socket of the commercial power supply is received when electric power is supplied, that the electric apparatus is connected to the commercial power supply and discriminate, when the predetermined signal is not received, that the electric apparatus is not connected to the commercial power supply. In this case, the connecting unit 103 only has to be configured not to transmit the controlled signal when the power supply plug is inserted. In recent years, in some case, information communication is performed by using a power line under the standards such as HD-PLC, HomePlug, AV, and Universal Power line Association (UPA). For example, it is possible to determine whether the electric apparatus is connected to the commercial power supply using information transmitted and received via a power line laid in a home as predetermined information under such power line communication standards.

It can be discriminated, based on resistance at a destination to which the power supply plug is connected, whether the electric apparatus is connected to the commercial power supply. In this case, the power-supply discriminating unit 104 measures the resistance at the destination to which the power supply plug is connected. For example, when the measured resistance is equal to or smaller than a reference value, the power-supply discriminating unit 104 discriminates that the electric apparatus is connected to the commercial power supply. When the measured resistance is larger than the reference value, the power-supply discriminating unit 104 discriminates that the electric apparatus is not connected to the commercial power supply. The reference value of the resistance as a reference for discrimination and a magnitude relation between the resistance and the reference value can be changed as appropriate according to the type and the configuration of the electric apparatus, the configuration of the power line for providing the commercial power supply, and the like.

The user can set whether the electric apparatus is connected to the commercial power supply in advance or connected to the service socket of the other electric apparatus. For example, the user can perform the setting with the switch provided in the DVD recorder 100 or can perform the setting by operating the electric apparatus with the remote controller or the like. In this case, when electric power is supplied via the power supply plug 102, the apparatus discriminating unit 105 only has to decide, based on the setting of the switch or the remote controller, whether the electric apparatus is the controlling-side electric apparatus or the controlled-side electric apparatus. When this configuration is adopted, the power-supply discriminating unit 104 can be made unnecessary.

The predetermined conditions for the power-supply control unit 106 to control supply and interruption of electric power are not limited to the reception of the operation and standby signals for the television receiver 101. For example, power consumption of the television receiver 101 is measured by the power-supply control unit 106. When the power supply is smaller than a reference value, it is possible to determine that the television receiver 101 shifts to the standby state and perform control for interrupting electric power.

When operation for using the television receiver 101, for example, operation for instructing playing of a DVD is applied to the DVD recorder 100, the power-supply control unit 106 can perform control for supplying electric power to the television receiver 101. It goes without saying that, when operation for stopping the use of the television receiver 101, for example, operation for stopping a DVD being played is performed, the power-supply control unit 106 can perform control for interrupting electric power to the television receiver 101.

FIG. 4 is a block diagram of the schematic configuration of an electric apparatus including a power-supply control device according to a second embodiment. In the second embodiment, as in the first embodiment, a DVD recorder 300 and a television receiver 301 are explained as examples of the electric apparatuses. Components same as those explained in the first embodiment are denoted by the same reference numerals and detailed explanation of the components is omitted. As in the first embodiment, in the explanation of the second embodiment, a connection configuration in which the DVD recorder 300 is a controlling-side electric apparatus and the television receiver 301 is a controlled-side electric apparatus is adopted.

In the second embodiment, a power-supply control device 20 of the DVD recorder 300 and a power-supply control device 21 of the television receiver 301 include communication units 209, information transmitting units 210 and 213, and recording units 211. The communication units 209 allow the electric apparatuses to transmit and receive various kinds of information to and from each other. For example, when the DVD recorder 300 and the other electric apparatus are connected by wire as in communication standards such as HDMI, IEEE1394, USB, and Ethernet (registered trademark), connectors or the like for connecting a communication line correspond to the communication units 209. When information is transmitted and received by wire as in communication standards such as Wireless LAN, Bluetooth, and UWB, antennas or the like correspond to the communication units 209.

The information transmitting unit 210 performs transmission and reception of information with the other electric apparatus at predetermined timing via the communication unit 209. The information transmitting unit 210 can store the information transmitted by the information transmitting unit 210 or the recording unit 211 or a hard disk drive explained later can store the information. The information transmitting units 210 and 213 transmit and receive information indicating power consumptions in the standby state of the electric apparatuses, i.e., standby powers.

The apparatus discriminating units 105 compare, separately from the decision of the controlling-side electric apparatus, the power consumptions transmitted and received by the information transmitting units 210 and 213. When the power consumption of the DVD recorder 300 is larger than the power consumption of the television receiver 301, an effect of a reduction in the standby powers is larger when power supply control is performed with the DVD recorder 300 set as the controlled-side electric apparatus. In this case, the apparatus discriminating units 105 notify a user that it is desirable to adopt a connection configuration in which the television receiver 301 as the controlled-side electric apparatus in the current connection configuration is set as the controlling-side electric apparatus. Specifically, the apparatus discriminating units 105 can cause a display unit of the television receiver 301 to display indication “please connect the television receiver to the socket of the commercial power supply”. The information transmitting units 210 and 211 function as power-information acquiring units that acquire information indicating the standby powers. The information transmitting units 210 and 213 also function as notifying units that notify a comparison result of the standby powers. The power-information acquiring units and the notifying units can be separately provided.

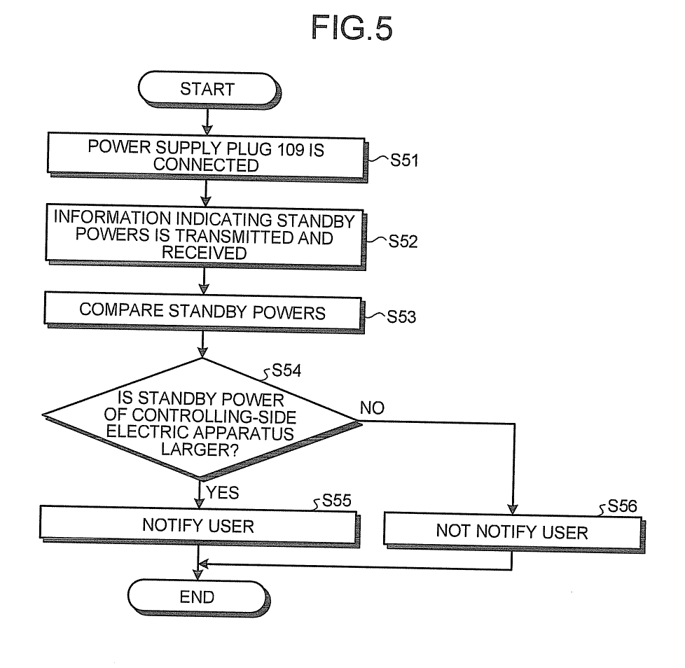

FIG. 5 is a flowchart for explaining a procedure for the apparatus discriminating unit 105 to discriminate, based on power consumptions, whether a connection configuration is appropriate for a reduction in standby powers. When the power supply plug 109 of the television receiver 301 is connected to the connecting unit 103 of the DVD recorder 300 (step S51), information indicating standby powers of the apparatuses are transmitted and received (step S52). The apparatus discriminating unit 105 on the television receiver 301 side compares the standby powers (step S53). When the standby power of the DVD recorder 300 as the controlling-side electric apparatus is larger (“Yes” at step S54), the television receiver 301 notifies the user that it is desirable to set the television receiver 301 as the controlling-side electric apparatus (step S55). When the standby power of the DVD recorder 300 as the controlling-side electric apparatus is smaller (“No” at step S54), because necessity for changing the connection configuration of the electric apparatuses is low, notification to the user is not performed (step S56).

It goes without saying that the apparatus discriminating unit 105 on the DVD recorder 300 side can discriminate, in the same procedure, whether a connection configuration of the electric apparatuses is appropriate and notify the user of a result of the discrimination. For example, the apparatus discriminating unit 105 on the DVD recorder 300 side can cause a display unit of a remote controller of the DVD recorder 300 to display indication that the connection configuration is inappropriate.

In this way, the standby power of the electric apparatus as the controlling-side electric apparatus and the standby power of the electric apparatus as the controlled-side electric apparatus are compared. Therefore, it is possible to propose to the user a connection configuration of the electric apparatuses that can more efficiently reduce the standby powers. Further, it is automatically discriminated whether a connection configuration of the electric apparatuses is appropriate for a reduction in the standby powers. Therefore, it is possible to make it less likely that the user feels it annoying to select an appropriate connection configuration.

Information transmitted and received by the information transmitting units 210 and 213 is not limited to the information indicating the standby powers. Examples of the information transmitted and received by the information transmitting unit 210 are explained below.

Information indicating presence or absence of the power-supply control devices 20 and 21, i.e., presence or absence of a function of the electric apparatuses for performing power supply control can be transmitted and received. Even when the standby power of the controlling-side electric apparatus is larger as a result of comparing the standby powers as shown in FIG. 5, unless the function for performing power supply control is present in the controlled-side electric apparatus, it is desirable not to change a connection configuration of the electric apparatuses. Therefore, it is possible to cause the apparatus discriminating unit 105 to determine, based on presence or absence of the function for performing power supply control, whether notification for urging the user to change the connection configuration should be performed.

When the DVD player 300 is decided as the controlling-side electric apparatus, the information transmitting unit 210 on the DVD player 300 side can transmit information for notifying that the television receiver 301 is the controlled-side electric apparatus. The television receiver 301 can be set not to perform discrimination of the controlling-side electric apparatus when this information is received. Therefore, it is possible to realize simplification of a procedure for discriminating the controlling-side electric apparatus.

The information transmitting unit 210 on the DVD recorder 300 side can transmit, when power supply control is performed, permission information for obtaining permission for supply and interruption of electric power. The information transmitting unit 213 on the television receiver 301 side that receives the permission information can transmit reply information indicating whether the supply and the interruption of electric power can be permitted. When update of firmware is performed in the television receiver 301 when the permission information is received, the information transmitting unit 213 transmits replay information for not permitting the interruption of electric power. This makes it possible to prevent a situation in which electric power is interrupted during the update of the firmware, the update ends incomplete, and a deficiency in terms of a system occurs.

The information transmitting unit 210 on the DVD recorder 300 side can inquire about a type and content of information that should be recorded by the recording unit 211 on the DVD recorder 300 side. The information transmitting unit 210 on the television receiver 301 side transmits information indicating the type and the content of the information that should be recorded by the recording unit 211 on the DVD recorder 300 side. For example, the information transmitting unit 210 transmits, as the information indicating the type and the content of the information that should be recorded by the recording unit 211 on the DVD recorder 300 side, time information, scheduled viewing information, and the like that are likely to be lost because of interruption of electric power.

When supply of electric power to the television receiver 301 is started, the information transmitting unit 210 on the DVD recorder 300 side transmits the time information recorded in the recording unit 211. The television receiver 301 can reset, based on these kinds of information, time of a clock incorporated therein. The user does not need to perform time setting and the like every time electric power is supplied to the television receiver 301. Therefore, it is possible to improve convenience of use of the DVD recorder 300 and the television receiver 301.

The power-supply control unit 106 of the DVD recorder 300 can perform power supply control using the information recorded in the recording unit 211. For example, the power-supply control unit 106 can be configured to supply, referring to the scheduled viewing information recorded in the recording unit 211, electric power to the television receiver 301 when viewing start time comes.

The information transmitting unit 213 on the television receiver 301 side can transmit information indicating maximum power consumption of the television receiver 301. The power-supply control unit 106 of the DVD recorder 300 can discriminate whether the maximum power consumption of the television receiver 301 as a target of power supply control is within permissible power. When the power-supply control unit 106 discriminate that the maximum power consumption of the television receiver 301 is larger than the permissible power of the DVD recorder, the power-supply control unit 106 can urge the user to directly connect the television receiver 301 to the socket of the commercial power supply. For example, the power-supply control unit 106 can cause the display unit of the television receiver 301 or the display unit of the remote controller to display warning indication.

The information transmitting unit 213 on the television receiver 301 side can transmit information indicating a communication standard and information indicating a communication protocol of the remote controller of the television receiver 301. The DVD player 300 performs various kinds of setting based on, for example, the received information indicating the communication standard such that the DVD player 300 can receive and understand an operation signal and the like sent from the remote controller of the television receiver 301 to the television receiver 301. Consequently, even when the DVD recorder 300 uses, between the DVD recorder 300 and a remote controller thereof, a communication protocol different from that of the remote controller of the television receiver 301, the DVD recorder 300 can understand an operation instruction from the remote controller of the television receiver 301 and perform power supply control and the like.

The electric apparatuses can transmit and receive identification information with which the electric apparatuses can identify the electric apparatuses each other. Examples of information with which the electric apparatuses can identify the electric apparatuses each other include MAC addresses, global IDs, and identification numbers. The received identification information can be recorded in the recording unit 211. The recording unit 211 is a recording medium that records various kinds of information such as the identification information. In the DVD recorder 300, a hard disk drive that records program information and the like can also be used as the recording unit 211. A recording medium can be separately provided. All the kinds of information as the examples of the information to be transmitted and received can be recorded in the recording unit 211.

When transmission and reception of identification information is performed, the information transmitting unit 210 compares the identification information already recorded in the recording unit 211 and the received identification information. When the identification information already recorded in the recording unit 211 and the received identification information coincide with each other, the information transmitting unit 210 determines that the electric apparatus connected to the connecting unit 103 is not changed from the electric apparatus connected to the connecting unit 103 when electric power is supplied before. For example, when the information transmitting unit 210 determines that the electric apparatus is not changed, the reset of the communication protocol of the remote controller, the comparison of the permissible power and the maximum power consumption, and the like are not performed. This makes it possible to realize simplification of a control procedure.

In the embodiment explained above, each of the power-supply control device 20 and 21 has only one connecting unit. However, the power-supply control device can have a plurality of connecting units. For example, it is possible to provide a plurality of connecting units in the DVD player 300 and simultaneously connect a speaker and an amplifier besides the television receiver to perform power supply control.

While certain embodiments have been described, these embodiments have been presented by way of example only, and are not intended to limit the scope of the inventions. Indeed, the novel devices and methods described herein may be embodied in a variety of other forms; furthermore, various omissions, substitutions and changes in the form of the devices and methods described herein may be made without departing from the spirit of the inventions. The accompanying claims and their equivalents are intended to cover such forms or modifications as would fall within the scope and spirit of the inventions.

What is claimed is:

1. A power-supply control device provided in an electric apparatus connected to a commercial power supply, the power-supply control device comprising:
a connecting unit to which a power supply plug can be connected;
an apparatus discriminating unit that discriminates whether the electric apparatus is a controlling-side electric apparatus that controls supply of electric power via the power supply plug connected to the connecting unit;
a switching unit that switches supply and interruption from the connecting unit of electric power supplied from the commercial power supply; and
a control unit that controls the supply and the interruption of electric power by the switching unit when the apparatus discriminating unit discriminates that the electric apparatus is the controlling-side electric apparatus.

2. The power-supply control device according to claim 1, further comprising a power-supply discriminating unit that discriminates that the electric apparatus is connected to the commercial power supply, wherein
the apparatus discriminating unit discriminates, when the power-supply discriminating unit discriminates that the electric apparatus is connected to the commercial power supply, that the electric apparatus is the controlling-side electric apparatus.

3. The power-supply control device according to claim 2, wherein the power-supply discriminating unit discriminates, based on resistance at a destination to which the electric apparatus is connected, whether the electric apparatus is connected to the commercial power supply.

4. The power-supply control device according to claim 2, wherein the connecting unit transmits, via the power supply plug connected to the connecting unit, a controlled signal indicating that the electric apparatus is connected to the connecting unit.

5. The power-supply control device according to claim 1, further comprising a switch that can set whether the electric apparatus is the controlling-side electric apparatus, wherein
the apparatus discriminating unit discriminates, based on setting of the switch, whether the electric apparatus is the controlling-side electric apparatus.

6. The power-supply control device according to claim 1, further comprising a transmitting unit that transmits an operation signal to another electric apparatus connected to the connecting unit, wherein
the control unit causes, when electric power is supplied to the other electric apparatus, the transmitting unit to transmit the operation signal.

7. The power-supply control device according to claim 1, wherein the control unit causes, when a standby signal to another electric apparatus connected to the connecting unit is received, the switching unit to interrupt electric power to the other electric apparatus.

8. The power-supply control device according to claim 7, wherein the control unit causes, when a fixed time elapses after the standby signal to the other electric apparatus is received, the switching unit to interrupt electric power to the other electric apparatus.

9. The power-supply control device according to claim 1, further comprising:
a communication unit that enables transmission and reception of information to and from another electric apparatus connected to the connecting unit;
a standby-power acquiring unit that acquires information indicating standby power of the other electric apparatus via the communication unit;
a comparing unit that compares the standby power of the other electric apparatus and standby power of the electric apparatus; and
a notifying unit that notifies a user of a comparison result when the standby power of the electric apparatus is larger than the standby power of the other electric apparatus as a result of the comparison by the comparing unit.

10. The power-supply control device according to claim 1, further comprising:
a communication unit that enables transmission and reception of information to and from another electric apparatus connected to the connecting unit; and
a recording unit that stores the information acquired by the communication unit.

11. A power-supply control method for controlling, in an electric apparatus connected to a commercial power supply, supply and interruption of electric power supplied from the commercial power supply to another electric apparatus connected to the electric apparatus, the power-supply control method comprising:
discriminating whether the electric apparatus is a controlling-side electric apparatus that controls supply of electric power to the other electric apparatus; and
controlling the supply and the interruption of electric power supplied from the commercial power supply to the other electric apparatus.

12. The power-supply control method according to claim 11, further comprising
discriminating that the electric apparatus is connected to the commercial power supply; and
discriminating, when it is discriminated that the electric apparatus is connected to the commercial power supply, that the electric apparatus is the controlling-side electric apparatus that controls the supply of electric power to the other electric apparatus.

13. The power-supply control method according to claim 12, wherein the discrimination concerning whether the electric apparatus is connected to the commercial power supply is performed based on resistance at a destination to which the electric apparatus is connected.

14. The power-supply control method according to claim 12, further comprising transmitting, to the other electric apparatus, a controlled signal indicating that the electric apparatus is connected to the connecting unit.

15. The power-supply control method according to claim 11, further comprising discriminating, based on setting of a switch that can set whether the electric apparatus is the controlling-side electric apparatus, whether the electric apparatus is the controlling-side electric apparatus.

16. The power-supply control method according to claim 11, further comprising transmitting an operation signal to the other electric apparatus when electric power is supplied to the other electric apparatus.

17. The power-supply control method according to claim 11, further comprising interrupting electric power to the other electric apparatus when a standby signal to the other electric apparatus is received.

18. The power-supply control method according to claim 11, further comprising interrupting electric power to the other electric apparatus when a fixed time elapses after a standby signal to the other electric apparatus is received.

19. The power-supply control method according to claim 11, further comprising:
performing transmission and reception of information to and from the other electric apparatus to acquire information indicating standby power of the other electric apparatus;
comparing the standby power of the other electric apparatus and standby power of the electric apparatus; and
notifying a user of a comparison result when the standby power of the electric apparatus is larger than the standby power of the other electric apparatus.

20. The power-supply control method according to claim 11, further comprising storing information transmitted to and received from the other electric apparatus in a recording unit.
